(19) United States
(12) Patent Application Publication
(10) Pub. No.: US 2013/0204875 A1
(43) Pub. Date: Aug. 8, 2013

(54) Automatic Configuration Of A Product Data Management System

(71) Applicant: Andreas Pielok, Wuerzburg (DE)

(72) Inventor: Andreas Pielok, Wuerzburg (DE)

(21) Appl. No.: 13/749,757

(22) Filed: Jan. 25, 2013

Related U.S. Application Data
(60) Provisional application No. 61/590,855, filed on Jan. 26, 2012.

(30) Foreign Application Priority Data
Jan. 26, 2012 (DE) 102012001406.6

(51) Int. Cl. G06F 17/30

(52) U.S. Cl. CPC G06F 17/30705
USPC 707/737

(57) ABSTRACT

The invention relates to a computer-implemented configuration system, a method of configuration and a computer program product. The configuration system serves to automatically configure a product data management system (P). The product data management system (P) serves to manage parts data sets (100) which represent medico-technical parts in the field of medical engineering. The configuration system takes into account parts data sets (100) classified and labelled during the automatic configuration according to the ECL@SS standard, specific configuration requirements (600) of the product data management system (P) and process conditions (500) of a treatment process in respect of the medico-technical parts. The configuration instructions (700) can be forwarded in an xml file to the product data management system (P) for configuration.

### CROSS-REFERENCE TO RELATED APPLICATIONS

The present application claims the benefit of the filing date of U.S. Provisional Patent Application Ser. No. 61/590,855 and German Patent Application No. 102012001406.6, both filed by the present inventor on Jan. 26, 2012.

The aforementioned provisional patent application is hereby incorporated by reference in its entirety.

### BACKGROUND OF THE INVENTION

1. Field of the Invention

The present invention lies in the fields of medical engineering and information technology and in particular relates to the configuration of a product data management system within the framework of the development and production of medico-technical machines and parts. These include in particular products in the field of dialysis, in particular concerning haemodialysis machines and peritoneal dialysis machines, as well as associated disposables.

2. Brief Description of the Related Art

Electronic product data management systems (PDM systems for short) are known in the state of the art for managing production parts and processes within the framework of product development and production. Hitherto it has been customary to call these systems EDM systems (engineering data management systems). Depending on the type of product data management system in question different functionalities can be provided, in particular comprising production-related information and coordination functions. A product data management system is typically formed as a software system and comprises a large number of interfaces, say with ERP systems (enterprise resource planning systems), systems for computer-aided drafting and computer-aided design (computer aided design—CAD systems) or document managements systems (DMS). Product data management systems can also be used for different sectors of a business but also for different businesses of an association of companies. Depending on the technical orientation of the product or of the business each of the related product data management systems displays differences. Basically, the product data management systems are sector- or product-specific. Today, a large number of commercial product data management systems are on the market, for example the “PRO.FILE” system from PROCAD GmbH & Co. KG, but for example also SAP-based solutions, for example the “mySAP” system from SAP AG which is an expansion of an R/3 ERP system to include product data management.

All product data management systems are based on a (digital) modelling of the respective development and production process (here for example for dialysis machines) and require an information-technology structuring or organization using corresponding information models. Digital data sets represent real, physical products and/or machines from the production sector (here dialysis machines). The underlying information models are based on a specific data structuring and/or on a specific classification system.

Different classification systems are known in the state of the art. These include, for example, different versions of the ECL@SS system or, for the field of electrical engineering, classification systems from the ETIM-Deutschland initiative (electrical engineering information model) for product data in the electrical engineering sector.

Product data management systems are generally based on a specific classification system. The difficulty in the state of the art of using a product data management system unchanged if the product data have to be newly classified or reclassified is a disadvantage. A corresponding adaptation of the product data management system is necessary as a result. However, at high volumes of data this can lead to expenditure in terms of time and cost that is not to be underestimated.

Starting from the above-named state of the art the object of the present application is to provide a computer-implemented system which can easily, quickly and automatically be adapted to dynamically changeable production and development processes and data models, changed demands for parts and/or changed conditions of use. In particular an existing product data management system is to be automatically configurable.

Furthermore it is intended to be possible to analyze a large volume of data comprising parts data sets in order to configure a product data management system on the basis of the analyzed parts data sets. Equally, errors which have previously occurred in the state of the art due to manual misconfigurations are to be avoided. Finally, the flexibility of existing product data management systems is to be increased.

This object is achieved by the attached coordinated claims, in particular by a computer-implemented system, by a computer-implemented method and a computer program product.

The invention is described below with the help of the solution according to the system. Features, alternative embodiments and advantages mentioned in the process are also solutions proposed to achieve the object, thus in particular to the method and the computer program product. In other words the other types of claim (method, computer program product) can be developed with the features which are described and/or claimed in conjunction with the system and vice versa. A specific method step of the method corresponds to a module of the system which is intended to carry out the respective functionality of the method step and vice versa. The modules of the system can be designed as hardware modules, in particular microprocessor modules. In a preferred embodiment the system can even be incorporated, as an “embedded system”, into a more comprehensive technical system. Equally, the system can also be incorporated directly into a production system. The microprocessor or the system can also be realized to exchange data with other computer-implemented entities, in particular with memory modules, databases, bus systems, other computers from the same or a different business.

According to an aspect of the invention a computer-implemented system is provided for configuring an electronic product data management system for processing technical parts data sets. The parts data sets represent in particular medico-technical parts, for example in the field of dialysis technology and stored (but the invention is not limited to this field), and are stored classified and labelled according to a classification protocol in a data structure of a physical data memory. In a preferred embodiment the system comprises the following modules or entities:
a parts data set interface. This interface is intended to read in the classified and labelled parts data sets from the data memory.
a product data management system interface. This interface is intended to read in configuration requirements of the product data management system.
a process memory. This process memory serves to store acquired process conditions in respect of a process (e.g. a production process, a treatment process or a production process) for processing and/or using medico-technical parts. The respective conditions of the business or sector of business for the production of medical parts are modelled in the process conditions. Thus different sectors, businesses or sectors of business usually have different process conditions.
A process-adapted data structure for the parts data sets. The process-adapted data structure is not usually the same as the data structure according to which the parts data sets were classified and labelled with the help of the classification protocol. The process-adapted data structure is characterized in that the process conditions (thus comprising business-specific parameters) are taken into account.
The system also comprises a configuration memory which is intended to store configuration instructions based on the acquired process conditions and/or based on the read-in configuration requirements. The configuration requirements represent the demands and conditions stipulated by the respective product data management system. Depending on the type and/or version of the respective product data management system, different configuration requirements are taken into account here.
A configurator which is intended to automatically configure the product data management system can be described as core module of the system according to the invention. The configurator serves to import the process-adapted data structure into the product data management system and to activate the configuration instructions have been read out from the configuration memory and are used in the PDM system.

According to a preferred embodiment the configurator serves to automatically generate at least one configuration file. The configuration file(s) can then be used to optimally configure the product data management system and in the process to adapt this to match the respective process conditions of the business and the respective configuration requirements of the product data management system itself.

The concepts used within the framework of this application are explained in more detail and defined below.

The term “configuration” (or “configurator”) of the product data management system comprises an adaptation, a change in an existing product data management system, a reconfiguration and/or the automatic acquisition of specific settings or the overwriting of default settings of operating parameters of the product data management system. Preferably the term configuration refers to a software-side configuration. Alternative embodiments relate to a configuration at hardware level, for example comprising a configuration of a plug-in module for a computer, device drivers, data memories or databases and/or other machines. An essential feature of the present application is also to be seen in the configuration taking place on the basis of actually used parts data sets (which have possibly been read in via the parts data set interface in a preparatory phase). Thus it can advantageously be ensured that the configuration of the product data management system is carried out on the basis of real data and only classes and labels selected as relevant are taken into account. In other words those classes or labels which, while they exist in principle and would be present in the respective classification protocol, are not used for the respective production of the parts, or in the configuration of the product data management system. Additional expenditure which otherwise would arise through unnecessary calculations can thereby be avoided. A further aspect of the configuration is to be seen in that this is carried out in automated form. Thus the configuration can be carried out much more quickly than in the case of the manual configuration hitherto used in the state of the art. Furthermore the configuration is correct from the point of view of information technology, i.e. it leads to a calculable result that can safely be released and is error-free. The configuration is based on the generation of information models (modelling). This belongs to the field of Software Engineering and requires an addressing of the technical conditions. Here, technical knowledge of context, for example that “screws” are connecting elements and basically have a thread, a diameter, a length, and varying head shape plays a part. A screw can be unambiguously identified by these features. However, this technical contextual knowledge also includes information about available technical interfaces (e.g. usable protocols), about input parameters, about the available bandwidth when transmitting data etc. The modelling is part of the process-oriented procedure modelling within the framework of Software Engineering. The subject of the modelling which forms the basis of this application relates exclusively to technical products, machines or information-technology conditions.

In a preferred embodiment the “PRO.FILE” system from PROCAD GmbH & Co. KG is used as product data management system. Alternative embodiments here provide for other product data management systems (possibly also from other suppliers). In principle the product data management system serves to electronically process parts data sets which represent medico-technical parts. The parts data sets are thus digital data which can be electronically processed by means of a computer. The treatment comprises a digital data processing with different functionalities, an electronic administration or a management of the parts data sets, the production or manufacture of parts data sets and generally all computer-based procedures and functions within the framework of the respective parts (including: production of the part, ordering of the part or of components of the part, spare parts management, storage, installation instructions etc.). According to a preferred embodiment the parts all come from medical engineering and in particular from dialysis technology. These include for example haemodialysis machines, peritoneal dialysis machines, filters, tube sets and other products, items or disposables which are processed and/or used within the framework of the production of dialysis technology products. However, other parts or products from other technical fields (e.g. electrical engineering, mecatronics or medico-technical physical systems) can also be taken into account.

The classification protocol preferably has a four-step hierarchy and/or is based on an ECL@SS standard. For example version 6.0.1 of the ECL@SS standard can be taken into account here. Alternatively, however, other classification protocols and/or other versions of the ECL@SS standard can also be processed. In principle it is to be noted that the solution according to the invention is not limited to a specific classification protocol. It is essential that with the configuration according to the invention only relevant classes and labels from the respectively used classification protocol (thus for example from the ECL@SS standard) are selected and adopted to generate the process-adapted data structure. Thus the relevant and necessary classes and labels are selected according to need from the ECL@SS 6.0.1 standard and adopted for standardized and data sheet parts of a production sector (here dialysis machines) within the framework of the configuration. The classification protocol serves to structure the electronic parts data sets. The classification protocol is based on a specific data structure and includes classes (preferably 4) and labels (or features) which are relevant to a specific production sector, such as for example “screw/nut”, with diameter X, with/without a head, of length Y, with thread Z etc. All parts data sets are already classified and labelled. Alternatively, such a data structure is produced for the electronic parts.

The “configuration requirements” are rules, prerequisites and/or defaults in respect of the product data management system. These are provided in electronic form and are digitally encoded. Here in particular all methods are defined which are relevant to the development and/or for the importing/exporting of class structures, definitions of features, definitions of fields, masks, configurations (including layout), configurations of lists, checking functions, selection functions or other mask layouts, as well as all system labels for the product data management system. In other words all requirements which must be taken into account for configuring the product data management system are brought together here. Preferably the configuration requirements are specifically matched or related to the parts data sets, with the result that the configuration requirements are set on the basis of the classified and labelled parts data sets or material master records of a production sector.

The configuration requirements are preferably specific to the PDM system and/or production sector.

The “process conditions” relate to prerequisites, conditions, defaults and/or requirements of the respective production sector (here for dialysis machines). The process conditions are likewise converted into electronic data sets or already exist in digital form. In principle the process conditions relate to a process for processing or for using the respective medico-technical parts. The respective prerequisites are thus modelled in a specific product sector and displayed. The process conditions are process-specific and generally application-specific; thus they relate to a specific sector of the business and/or production. The term “process” refers to a production process, treatment process for the respective parts or to a process in which the respective parts are used. The process conditions are thus based on technical prerequisites of the production process of the medico-technical parts. For the product sector of dialysis machines the following processes may be named here by way of example: production, development, use, application of parts of processing of product sector data of medico-technical parts.

Two different data structures are provided in an advantageous embodiment of the invention: firstly a data structure which contains parts data sets which are classified and labelled according to the classification protocol, in particular according to the ECL@SS standard. Furthermore, a process-adapted data structure is provided which according to the invention is generated automatically and in which the parts data sets are structured on the basis of the acquired process conditions and/or on the basis of the read-in configuration requirements. The process-adapted data structure contains only those parts data sets which have been selected as relevant. It is also possible to subject the parts data sets to a checking and/or validation process before they are stored in the process-adapted data structure. This has the advantage that the quality of the configuration process can be improved overall, as only validated and checked parts data sets are used.

According to a further aspect of the invention configuration instructions are generated automatically. The configuration instructions are computer-implemented commands or command data which are intended for configuring the product data management system on the basis of the acquired process conditions and/or on the basis of the read-in configuration requirements. The configuration instructions can for example be used to produce specific masks or graphic user interfaces (e.g. for title definitions, field specifications etc.). The instructions are compatible with the product data management system, can be read in, processed or carried out by same and can be structured as a configuration file (e.g. xml). Preferably, configuration instructions are automatically generated from the configuration requirements of the product according to preconfigured criteria. The configuration instructions are computer-readable commands which can be carried out upon activation (in particular commands which can be read by the product data management system and for this are subjected, if required, to a conversion process). The conversion serves to convert the instructions into such a format that they can also be read in and evaluated by the PDM system. This preferably takes place automatically. The configuration instructions serve to automatically generate input masks for title definition, field specification and/or label aggregation. When generating these masks both the configuration requirements of the respective product data management system (e.g. in respect of type of masks allowed, number, size etc.) and the process conditions (e.g. production conditions of the dialysis machines) for the parts are taken into account.

The configurator serves to automatically configure the product data management system. This takes place preferably by automatically producing at least one configuration file which can be read, directly or indirectly, (through the agency of further computer-based entities) into the product data management system. The configuration preferably comprises two aspects:
1. importing the process-adapted data structure into the product data management system. In particular only those classes and labels selected as relevant, and further subparameters, are taken into account. The automatically generated process-adapted data structure is thus transmitted to the product data management system (for example via a network or by reading in configuration files). The installation/importing also comprises a reconfiguration if the data are present in a different format and still need to be converted. The process-adapted data structure is to be used in the product data management system.
2. activation of configuration instructions. This comprises computer-implemented commands which can be read in and carried out inside the product data management system. The configuration instructions serve i.a. to automatically generate input masks for the product data management system and possibly for configuring the layout (selection of the fields, determination of sizes, request for parameters, unit consolidation, determination of data types, determination of field length, accuracy, visible length, admissibility of specific inputs etc.). The configuration instructions are preferably cached in a configuration memory.

As already stated above, an advantageous development of the invention relates to an automatic checking for admissibility being carried out when the process-adapted data structure is generated. Here, for example, it can be checked and ensured that only validated classifications and validated features or labels are taken into account when configuring the product data management system. Additionally, further inheritance rules can be provided here according to which specific classes and/or labels can be inherited in the classification hierarchy. If for example a specific feature is affirmed in a superordinated class (screw with head), then it can automatically be preset that all lower classes likewise inherit this feature (hexagon-head screw with head likewise inherits the feature “head”). Thus on the one hand the configuration and processing of configuration- and PDM-relevant data can be carried out more efficiently and on the other hand it can be ensured that only production sector-relevant, classified and validated material masters are taken into account for configuring the product data management system. The configuration comprises an interface configuration which generally refers to the automatic generation of user interfaces and furthermore comprises a structure configuration which generally refers to the technical data structure.

Within the framework of validating the parts data sets it can be provided that an electronic identifier, for example a flag, can be placed, transmitted and/or stored, preferably together with the parts data set, if a positive validation signal can be acquired for a parts data set. This validation signal can either be input manually by a user via a user interface or the validation signal can be calculated automatically from other data.

In a preferred embodiment the configuration comprises the process-adapted data structure and the configuration instructions. Preferably the configuration-relevant data are brought together in a configuration file which is intended to import and/or export data into/out of the product data management system. In advantageous developments of the invention the configuration can also comprise further configuration data sets, for example metadata sets which refer to a point in time of the configuration or to a tracking of configuration sessions. Thus it is possible to store and retain all computer-implemented operations which have been carried out within the framework of configuration, in order for example to be able to initiate statistical evaluations.

An essential advantage of the solution according to the invention is to be seen in the fact that, during the configuration of the product data management system, parts data sets can also be validated, altered, deleted and/or added to the data structure. Furthermore, parts data sets from different data structures can also be read in. It is likewise possible that parts data sets can be read in from data structures which are classified and/or labelled according to different classification protocols. This proves to be very advantageous, as a validation of parts data sets can be carried out in parallel with the configuration of the product data management system. In other words, during the configuration of the product data management system, an adaptation and optimization can also be carried out in respect of the parts data sets. Thus the whole system can be designed in even more optimized form as unnecessary parts data sets are not used for configuration.

According to an aspect of the invention the configurator is intended to carry out or prompt specifically for each class an automatic generation of input masks based on the read-in parts data sets, the read-in configuration requirements and/or the acquired process conditions. The automatic generation of input masks also comprises a change to or adaptation of existing masks and/or a deletion of same. Naturally, completely new masks can of course also be generated.

Titles Definition:

The configuration comprises a title definition for masks and lists. The title definition is the method or the computer-implemented process for establishing the titles for the data fields and the list headings. For the “PRO.FILE” product data management system for example at least one title must be defined per data field. Further titles per field can optionally be defined as necessary. This is automatically taken into account in the configuration according to the invention.

Fields Specification:

The product data management system customarily comprises fields for which specifications must be set. The calculation is carried out for each current class, each current specialist field and simultaneously over all parts data sets. The configuration comprises basically a mask design or the shaping of different aspects of a user interface. Further configuration decisions are then made on the basis of this calculation. For example calculations of the type of data (e.g. float, string) are carried out here. Here e.g. the field length and the accuracy of the field are specified and/or a checking function is specified against changes to the real data.

Masks Design:

According to a preferred embodiment of the invention the design (contents: determining and selecting the parameters) and the layout (shape, size, structure etc.) of the input interfaces are automatically generated. Furthermore, when selecting a specific class a group box is provided which can be implemented as sub-element or as preconfigurable area of a user interface and which brings together specific specifications with a view to clarity of the user interface. If a specific class is selected within the framework of the configuration, the group box, the mask fields and lists are generated initially on the basis of the field specification. There is also a positioning for labels (fields, titles), a fixing of the size for the respective label, interface representations which result on the basis of label inheritance, definitions of maximum values in relation to a class, checking for individual values, a switching of the interface in respect of a configurable language.

The configuration also comprises a label aggregation. To use the parts data sets in the respective processes (e.g. operational production processes) n labels are brought together or aggregated to form a short text. The method of label aggregation serves to define the respective abbreviation.

An export function is also provided. The export function serves to automatically generate a configuration file which for example can be provided in an xml format and is intended to be immediately imported into the product data management system.

According to an advantageous aspect the configuration comprises, at class level, the automatic generation and/or allocation of keywords. A keyword is allocated to a feature of a combination of features. This can be carried out by means of a mapping protocol which provides for a 1:1 allocation between keyword and combination of features. The generation of keywords is used for more efficient searching in the data structures, wherein usual search criteria or search terms can be modelled and defined (by defining the keywords). The keywords are preferably generated at class level. A major advantage of keyword generation is to be seen in the fact that this likewise takes place on the basis of the actually present and read-in parts data sets. Thus it can be ensured that, on the one hand, only relevant keywords, and on the other hand, no duplications are generated. The allocation protocol, according to which one keyword each is allocated to a class, can be carried out in process-specific and/or product data management system-specific manner. In other words, when generating one keyword each, the process conditions and/or the configuration requirements of the product data management system can be taken into account.

According to a further aspect of the invention a grouping protocol is provided. The grouping protocol serves to form a group of parts data sets. The group can be formed according to preconfigurable properties. Here, preconfigurable labels are usually chosen. Alternatively the properties are calculated automatically in real time or manually determined by the user. The group is characterized by groups of parts data which are the same in the preconfigured labels. This has the advantage that the product data management system can be searched very flexibly and at the same time efficiently. As a rule, the label aggregation differs from the chosen keyword.

A further solution of the object consists of a computer-implemented method for configuring an electronic product data management system which is intended to process and/or manage parts data sets. The parts data sets represent medico-technical parts, in particular in the field of dialysis technology, and are classified and labelled in a data structure according to a classification protocol. The data structure can be stored in a physical data memory (e.g. in a database). According to an aspect the method comprises the following method steps:
reading-in of the classified and labelled parts data sets from the data memory. This takes place preferably via the parts data set interface.
reading-in of configuration requirements of the product data management system. This takes place preferably via the product data management system interface.
acquisition of process conditions. The process conditions relate to the production process of the medico-technical parts or to a technical process in which the medico-technical parts are used, such as for example an installation of parts, the production of the parts, the actual use of the parts in the environment of operational medical engineering (e.g. of parts within the framework of an extensive dialysis machine or other machines).
automatic generation of a process-adapted data structure. The process-adapted data structure is not usually the same as the data structure in which the parts data sets are present or from which the parts data sets are read-in. The process-adapted data structure is characterized in that it is adapted to the configuration requirements (of the respective product data management system) and/or to the process conditions (of the treatment process/use process of the medico-technical parts within the framework of the business). Furthermore the process-adapted data structure is based only on real data, thus on real material master records of parts of a production sector selected as relevant, classified and labelled.
in the last step an automatic configuration of the product data management system takes place. This is carried out preferably by importing at least one configuration file. The configuration comprises the importing of the process-adapted data structure into the product data management system and the activation of the configuration instructions, with the result that the configuration instructions are carried out in order to generate the corresponding masks. The configuration is preferably completely automatic or semi-automatic (and comprises specific confirmation signals from the user).

An aspect of the present invention also provides for the use of the above-described method for further measures in addition to the automatic configuration. Thus the method can for example also be used to reclassify the parts data sets read-in and structured according to a first classification protocol. A second classification protocol is accessed. Preferably a second data structure is produced which can also be implemented as process-adapted data structure and which is held in a separate data memory. The reclassified parts data sets can then be forwarded to other systems and computer-implemented entities for processing. Thus it is also possible to use one and the same PDM system, although the parts data sets are structured according to a changed classification protocol.

A further aspect of the invention relates to a computer program product according to the attached claim. It is likewise possible to implement the above-described method as a computer program. The computer program comprises program code for carrying out all method steps of the above-described method if the computer program is carried out in a computer or in a computer network or in a processor of a computer. The computer program can also be stored in a digital storage medium (e.g. mobile data medium such as a CD etc.). Alternatively the computer program can be retrieved, downloaded and/or carried out at a client over a network (e.g. over the Internet).

### BRIEF DESCRIPTION OF THE FIGURES

The invention is described in more detail below with further features, advantageous and alternative embodiments and advantages in conjunction with the attached Figures. There are shown in:

FIG. 1 a schematic representation of a configuration development system, as proposed by the invention according to a preferred embodiment and which illustrates the specialist context,

FIG. 2 likewise, a schematic overview of relevant influencing factors for the configuration according to a preferred embodiment,

FIG. 3 a schematic representation of participating computer-based entities,

FIG. 4 a schematic diagram of a data transmission within the framework of the configuration,

FIG. 5 a flowchart according to a preferred embodiment of the method according to the invention

FIG. 6: an exemplary representation of a mask for titles definition,

FIGS. 7, 7A, 7B, 7C and 7D show an exemplary representation of a mask for fields specification

FIGS. 8, 8A, 8B, 8C and 8D show an exemplary representation of a masks designer

FIGS. 9, 9A, 9B, 9C and 9D show an exemplary representation of a mask for a label aggregation.

### DETAILED DESCRIPTION OF EMBODIMENT EXAMPLES

The main environment of a configuration system or configuration development system according to the invention with a configurator K is explained in more detail below.

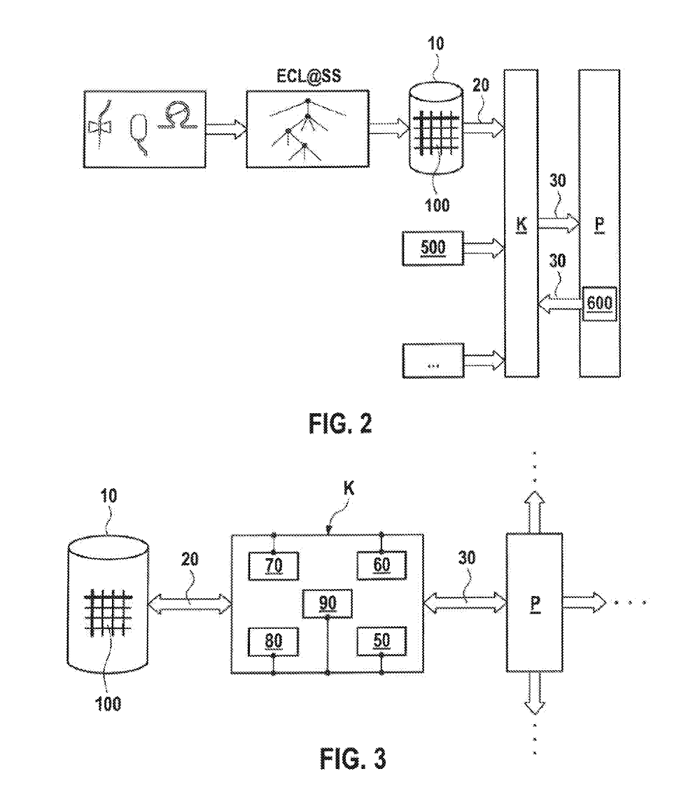

As represented on the left-hand side in FIG. 2, there is a number of parts which are used within the framework of a production process. In an embodiment of the invention these parts come from the production sector of medical engineering and concern in particular products, parts and/or machines in the field of dialysis technology. These include for example haemodialysis machines, peritoneal dialysis machines, filters, tube sets or other products or consumables which are used and/or produced within the framework of dialysis technology. Different product data management systems P are known in the state of the art for electronically managing the relevant electronic data sets, parts data sets numbered 100 below. These include for example the “Pro.File” product data management system P from Procad. Furthermore different classification protocols for describing and classifying the types and properties of products (via product descriptions, possibly combined with services) are known in the state of the art. An example of such a classification protocol which can be used within the framework of this application is the ECL@SS standard. With the help of the ECL@SS standard products can be structured to form classes or groups of products with similar product properties. ECL@SS is a hierarchical classification system which can be represented by means of a tree structure. Each object has an unambiguous identifier (IRDI—International Registration Data Identifier) which is based on the international standards ISO/IEC11179-6, ISO29002 and ISO6532. The ECL@SS standard is based on a four-step hierarchy. There are the following allocations:
1. Hierarchy level: Specialist field
2. Hierarchy level: Main group
3. Hierarchy level: Group
4. Hierarchy level: Sub-group.

Furthermore there are the following elements in this ECL@SS classification system:
classes. The classes permit a grouping or structuring of class elements (or objects) according to different criteria based on a taxonomy. The chosen taxonomy is, according to one aspect of the invention, production sector-specific.
keywords. Specific keywords and synonyms can be defined for searches in large volumes of data.
features. Features are product labels and describe properties of a product. Labels are generally class-specific, as products of a specific class have different features from products of another class.

There are different versions of the ECL@SS standard (including versions 4.0, 4.1, different versions of series 5 and 6 as well as a series 7) which, compared with previous versions, contain new classes, features, values and relationships of features to classes.

In an embodiment example of the invention the parts data sets 100 are in a structured form which is based on the ECL@SS standard 6.0.1. The parts data sets are in particular standardized and datasheet parts of the product sector for dialysis machines, classified and labelled according to ECL@SS 6.0.1. These parts data sets 100 are stored in a physical data memory 10.

To configure the product data management system P different initial variables are taken into account and processed fed to a configuration system K in the form of digital data sets. As schematically represented in FIG. 2, these are process conditions 500, configuration requirements 600 and optionally also further initial variables which are not shown in more detail in FIG. 2 and are to be indicated only by an empty box. These further values can for example be preconfigured specialist knowledge from the production sector or other metadata (for example time-related data). The process conditions 500 relate to a production process or to a use process for the medico-technical parts. Specialist knowledge from the respective product sector plays a part here and is forwarded in standardized form to the configuration system according to the invention. For example it is defined here which classes and labels and other objects from the ECL@SS standard are relevant for the respective product sector. Only the relevant objects are taken into account. This leads to an improvement in the efficiency of the configuration method.

The configuration requirements 600 are defaults, conditions or prerequisites of the product data management system P. Here all the knowledge in respect of the special product data management system P which is relevant for configuration plays a part. For example it can be defined here that with the Pro.File product data management system at least one title must be defined per data field or that in principle specifications (in respect of data type, field length, accuracy etc.) must be set for all fields.

These initial variables play a part in the configuration system K according to the invention which is intended to carry out the configuration of the product data management system P. The configuration system K is used for the dedicated configuration of the product data management system P. In FIG. 2 this is to be identified by the arrow which points from system K to system P.

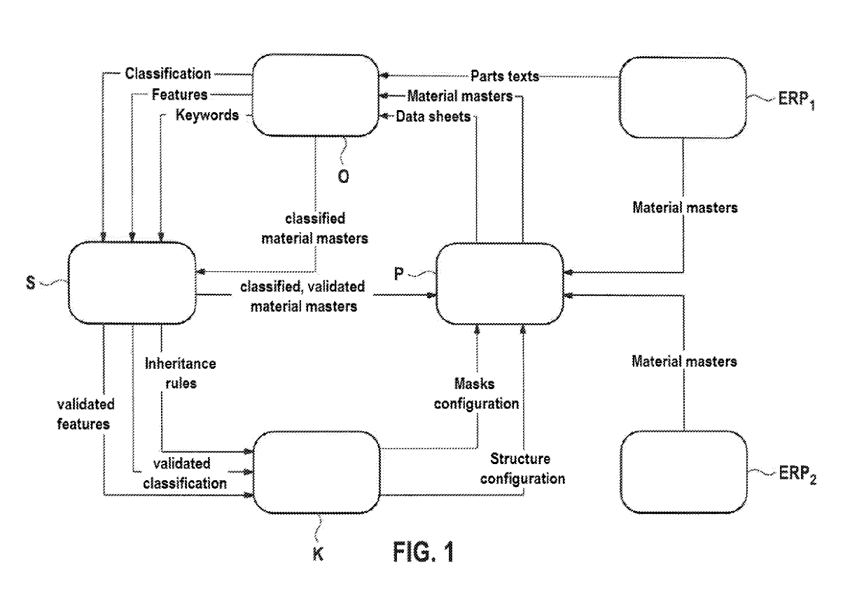

FIG. 1 shows a contextual overview of the configuration or configuration development system K according to the invention and delimits the same vis-à-vis adjacent systems which are connected to the configuration development system K via corresponding interfaces. The adjacent systems are ERP systems ERP₁, ERP₂ (ERP—Enterprise Resource Planning system), in particular software-based systems for resource planning of a business or sector of a business or associations of companies. The ERP systems ERPᵢ provide parts data sets, so-called material masters, and feed these via an input interface to the product data management system P. The ERP system ERP interacts with a so-called data optimizer O which is responsible for the quality of the stored data sets. Parts texts, material masters and/or datasheets are usually fed to the data optimizer O and the data optimizer O serves to produce, from these, at least a classification, features, keywords and/or classified material masters (thus parts data sets). These results from the data optimizer O are forwarded to a data validation and structuring system S. The data validation and structuring system S carries out a validation of the classification and of the features and serves to define inheritance rules. The validation and structuring system S provides the configuration system K with inheritance rules, a validated classification and validated features.

The configuration development system K according to the invention serves to develop and export class structures, features definitions, fields definitions, masks configurations, lists configurations, checking functions, choice functions, mask layouts as well as the definition and computer-based automated acquisition of all necessary classes and labels or features for the product data management system P. This takes place on the basis of classified and labelled material master records. As a result of this a data exchange between the configuration development system K and the product data management system P can be activated in order to send a generated structure configuration and a generated mask configuration to the product data management system P. As shown in FIG. 1, it is also possible to provide a direct data exchange between the data validation and structuring system S and the product data management system P. In particular the provided interface serves to forward classified and validated material masters from the system S to the product data management system P.

In a preferred embodiment it is provided, for the configuration system K according to the invention or for a configurator 90 (in which at least one part of the configuration system is implemented and which can be developed as hardware part or as memory to store at least one part of a computer-implemented configuration method) that preparatory measures are carried out on the parts data sets. These preparatory measures comprise a validation, a fine structuring, a labelling and a fine labelling (higher granularity description), taking into account the respective operational practice of the product sector (here: dialysis machines).

Bearing in mind the high volume of data of the parts data sets (for real data of the product sector of dialysis machines, for example, approx. 15,000 active standardized and data sheet parts or sets must be incorporated into an application-related configuration of the product data management system P), it is clear that an automated process, in particular an automatic configuration, is essential. The configuration system K according to the invention thus employs parsing strategies in order to analyze the material masters i.a. in respect of technical features and labels.

FIG. 3 schematically shows the structure of the configurator 90 or of the configuration system K according to the invention in the information technology environment. The ECL@SS classified and labelled parts data sets 100 are filed in the data memory 10 and are fed to the configuration system K via a parts data set interface 20. The configuration system K also exchanges data with the product management system P via a product data management system interface 30. It is naturally self-evident to a person skilled in the art that the configuration system K and/or the product data management system P can also have further interfaces. In FIG. 3 this is identified in relation to the product data management system P by the three further arrows.

The configuration system K comprises:
a process memory 50 which is intended to store the acquired process conditions 500.
a configuration requirements memory 60 which is intended to store the read-in configuration requirements 600 of the product data management system P.
a process-adapted data structure 70 for the parts data sets which structures the parts data sets on the basis of read-in configuration requirements 600 and/or on the basis of the acquired process conditions 500.
a configuration memory 80 which is intended to store configuration instructions. The configuration instructions can be converted by the product data management system P immediately for the parts real data.
a configurator 90. The configurator 90 serves to automatically configure the product data management system P. Usually the configurator 90 serves to produce a configuration file which contains activatable configuration instructions 700 which can be transmitted directly to the product data management system P for the configuration of same. Furthermore, the process-adapted data structure 70 can also additionally be imported into the product data management system P. The process-adapted data structure 70 and the configuration instructions 700 can be forwarded, either separately in the form of different messages or also jointly as a configuration packet, to the product data management system P in order to configure the latter. It is essential that the packet of the configuration message can be read directly by the product data management system.

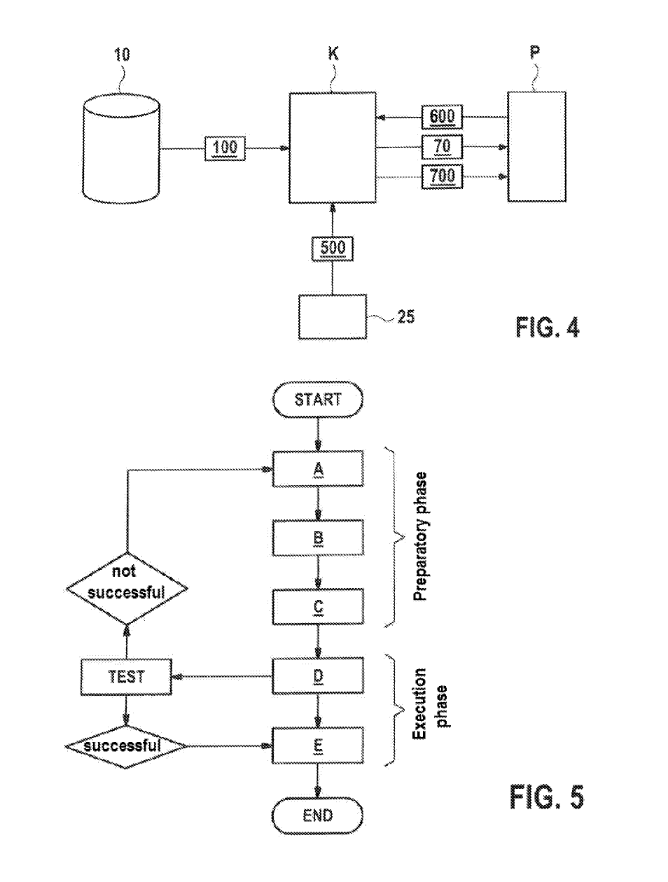

A preferred embodiment of the data exchange of the configuration system K is explained in more detail below with reference to FIG. 4 by way of example.

The configuration according to the invention is carried out on the basis of real data (of the material masters). This has the advantage that only relevant parts data sets 100 are used and the product data management system P does not have to deal with unnecessary waste data. The parts data sets 100 are read out from the data memory 10 and fed to the configuration system K via the parts data set interface 20.

The direction or providing of relevant real data is, however, not the sole characterizing factor of the configuration system K according to the invention, but further initial variables are read in and evaluated for automatic configuration. Thus in particular the process conditions 500 are read in. The process conditions 500 can be extracted from a production sector 25. Different aspects of the production sector 25 can be modelled using the process conditions 100. For example a unit consolidation can be carried out here. It is defined whether the respective labels are unit-neutral, or are to occur with one unit or with several units. In the latter case a separate field is defined for the unit and a selection list calculated for the units. If, otherwise, there is only one unit per label, the unit is placed afterwards—for example in square brackets—with the title of the label of the unit. Application-specific conditions of the production sector 25 thus play a part. For example, it will give different units for the label “diameter” depending on the production sector 25. If the production sector 25 is dialysis machines and the label “diameter” relates to tube sets, then it will make sense to use millimetres as unit, while the unit used will preferably be centimetres for the same label if for example the diameter of dialysis cases or the diameter of a blood pump is involved. Other quite substantial limitations (along the lines of influencing parameters) for the configuration result from the respective sector of the production sector 25. For example, the structure for parts data sets in the field of medical engineering, in particular for a plasma filtration, acute dialysis or haemodiafiltration will be different than for parts in the field of radiology, for example magnetic resonance tomography systems, computer tomographs etc. In addition to the orientation or the sector of the respective production sector 25 of the parts, the respective application plays a not inconsiderable role in the configuration according to the invention. Thus it is taken into account whether the parts are produced or whether they are applied within the framework of an operational use.

In addition to the process conditions 500 the configuration system K according to the invention also takes into account the configuration requirements 600 which result from the circumstances of the respective product data management system P. One influence among others in the case of the configuration requirements 600 is how the product data management system interface 30 is developed. Thus the format and optionally converting protocols as well as compression prerequisites can be defined here. Basically all configuration requirements of the respective product data management system P are displayed here. Via the definition of the configuration requirements 600 it is advantageously possible to carry out the adaptation of the configuration precisely matched to the respective product data management system P and to optimize it to meet its prerequisites. A further substantial advantage is to be seen in the fact that the method for configuration according to the invention is basically independent of the special formation of the product data management system P. The interfaces of the respective product data management system P and the specific prerequisites for defining the initial variables for the respective product data management system P can be defined via the configuration requirements 600. Thus the possibilities of using the configuration according to the invention are much greater, with the result that overall the flexibility can be clearly increased when configuring the PDM system P.

In summary the configuration according to the invention takes place on the basis of real data (via the reading-in of the parts data sets 100), is application-specific (by reading-in the process conditions 500) and/or is PDM-specific (by reading in the configuration requirements 600).

In an embodiment the process conditions 500 are stored in the process memory 50 of the configuration system K. The configuration requirements 600 are filed in the configuration requirements memory 60. From the acquired starting signals, the configurator 90 deduces specific configuration commands which are stored in the configuration memory 80 as configuration instructions 700 and can be forwarded at a choosable point in time to the product management system P for implementation or activation (advantageously optionally also at a later point in time). In addition to the configuration instructions 700 a process-adapted data structure 70 can also optionally be forwarded to the product data management system P. In a variant of the invention the configuration takes place exclusively on the basis of the configuration instructions 700 which for example can also be provided in the form of an xml file for import/export (xml: extensible markup language).

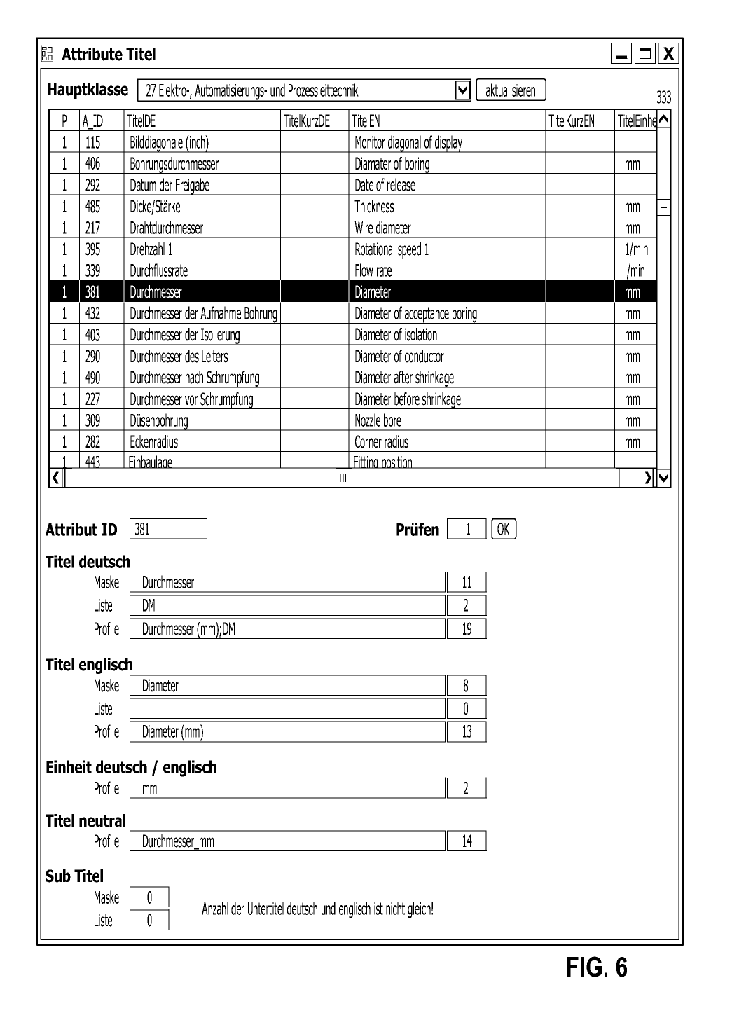

FIG. 6 shows an example of a mask for titles definition according to a preferred embodiment. For a specific production sector 25 it can be stipulated here that a maximum of two titles are defined per label, comprising a title for the field and a title for the list. On the basis of the acquired configuration requirements 600 it is analyzed whether there is one or more units each for a field. If only one unit is provided, the respective unit is represented in the title in square brackets. If there are several units a unit field is generated with a dynamic or dependent title (e.g. in the form: title_unit). Usually the titles are stipulated for one per specialist field each (of the respective production sector 25). Neutral titles are calculated from German titles; umlauts are converted and special characters replaced by a preconfigurable character. Usually it is provided that a title is unambiguously issued over the whole database. This is also thus taken into account in the configuration according to the invention. If inconsistent inputs (for example for the title) are acquired, it can be provided in an advantageous development of the invention that a warning is automatically generated on a user interface in order to notify the user that an inconsistent input has taken place here. When importing the classes into the product data management system P (for example via the process-adapted data structure 70) block numbers of the product data management system P are placed in front of the neutral titles. Here, also, different checking functions for data input during the configuration and further configuration settings can be defined. An example of a checking function is whether the number of titles is identical in all languages. As further configuration setting it can be checked whether the title length exceeds a maximum preset length (e.g. of 99 characters).

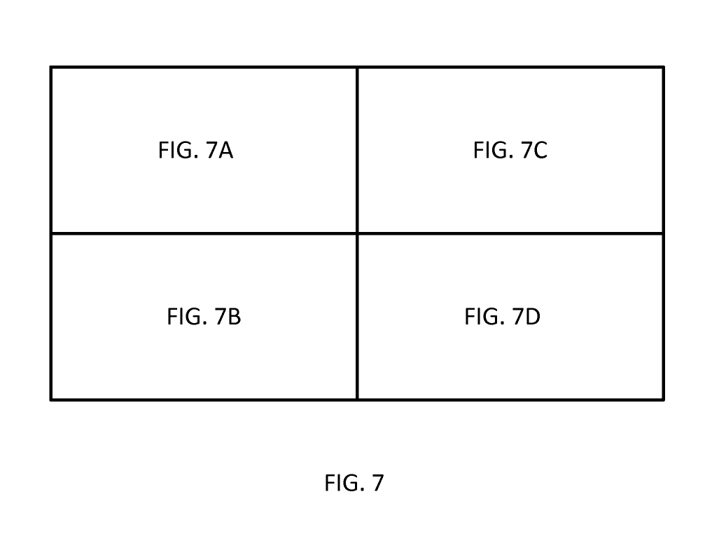

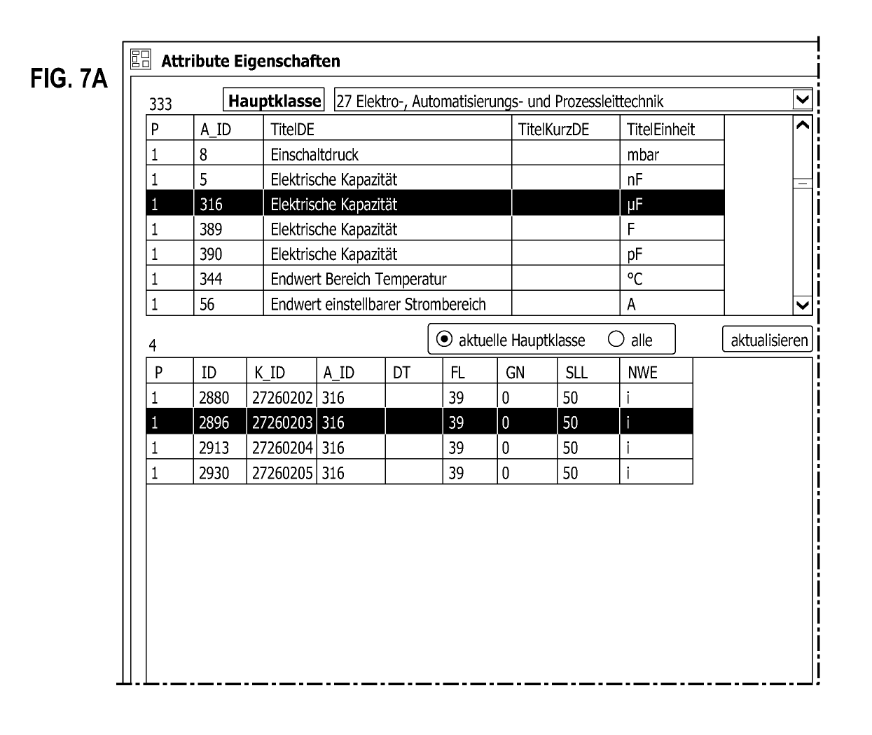

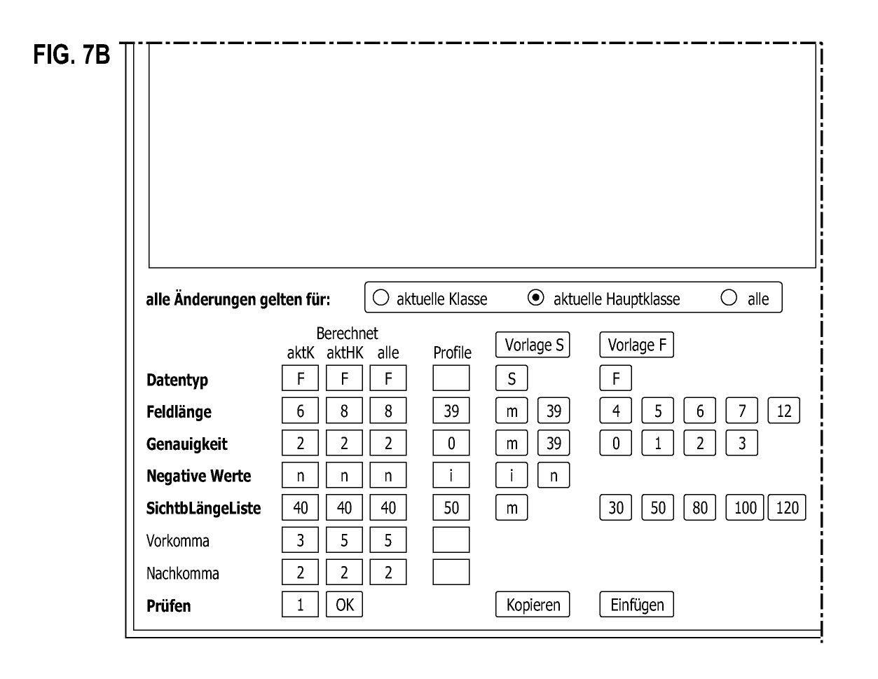

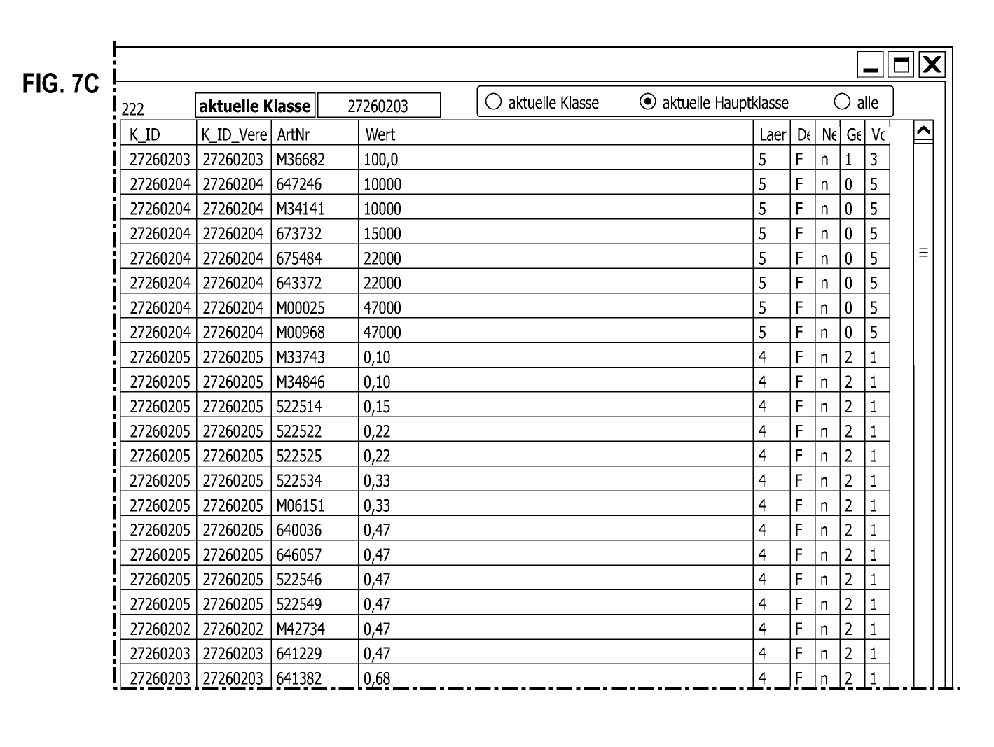

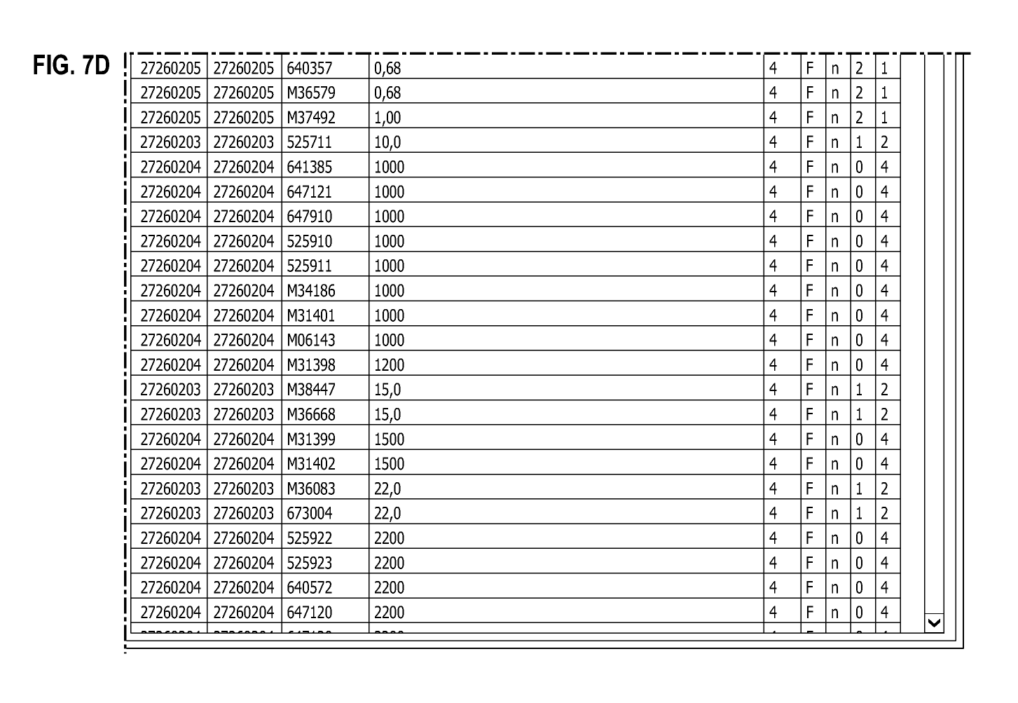

FIGS. 7 AND 7A-7D show by way of example a mask for field specifications. The type of data is preferably calculated here. It is necessary to indicate whether it is a float or a string data type for the Pro.File product data management system. The field length (calculating what or how many digits precede, and what or how many digits follow, the comma) and the accuracy are calculated. Likewise it is stipulated whether negative values are allowed and how long the visible length of the field in the list is to be. Checking functions for changing real data or the real parts data sets can also be defined.

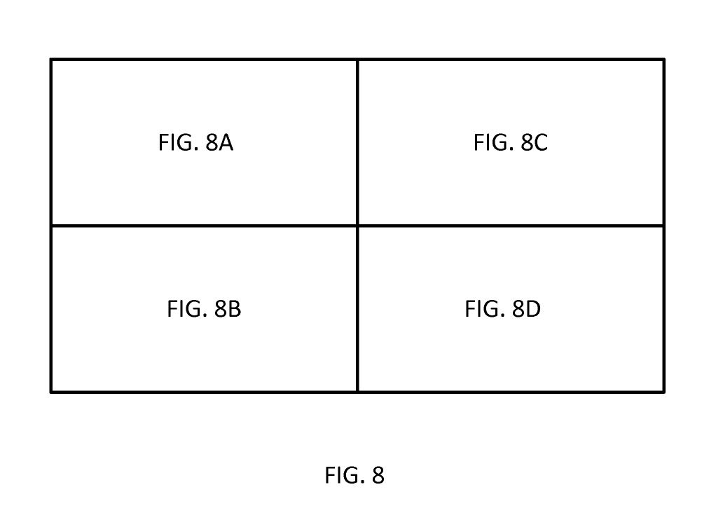

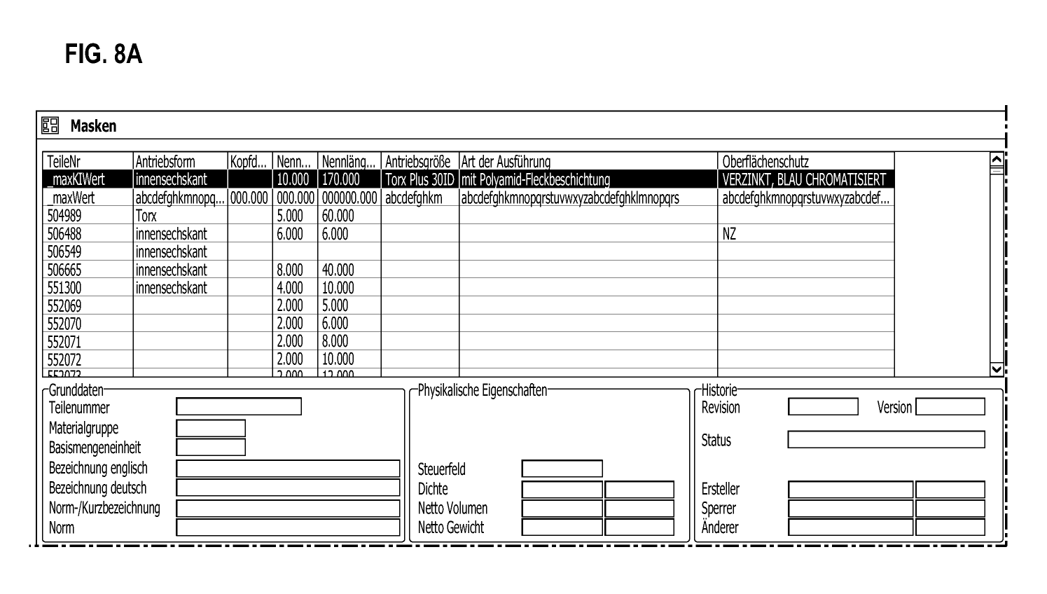

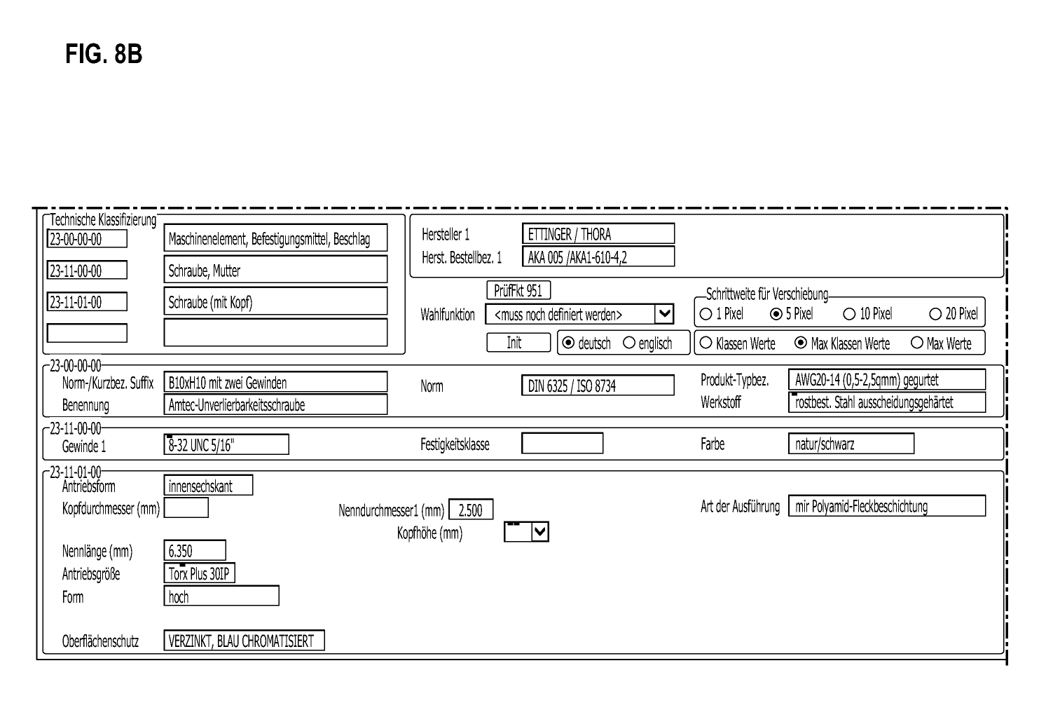

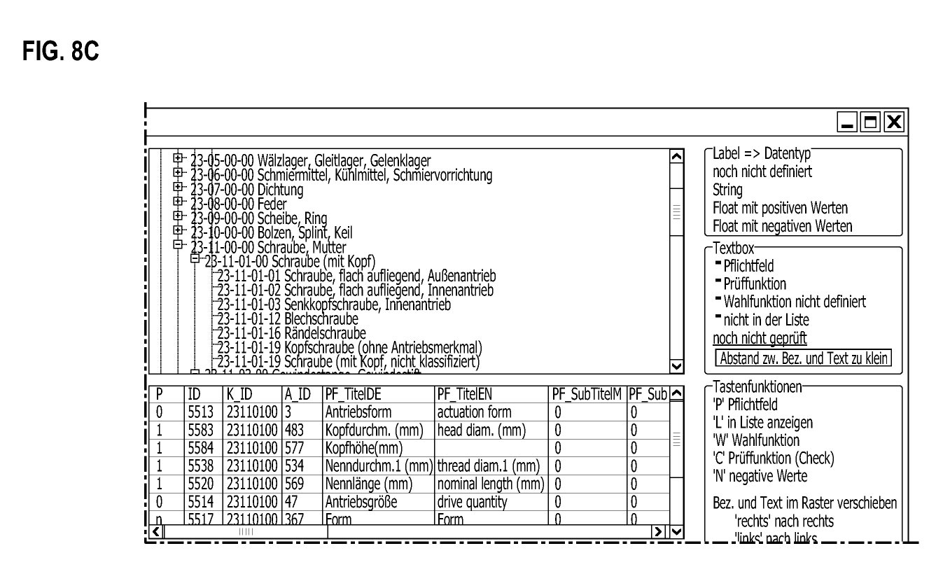

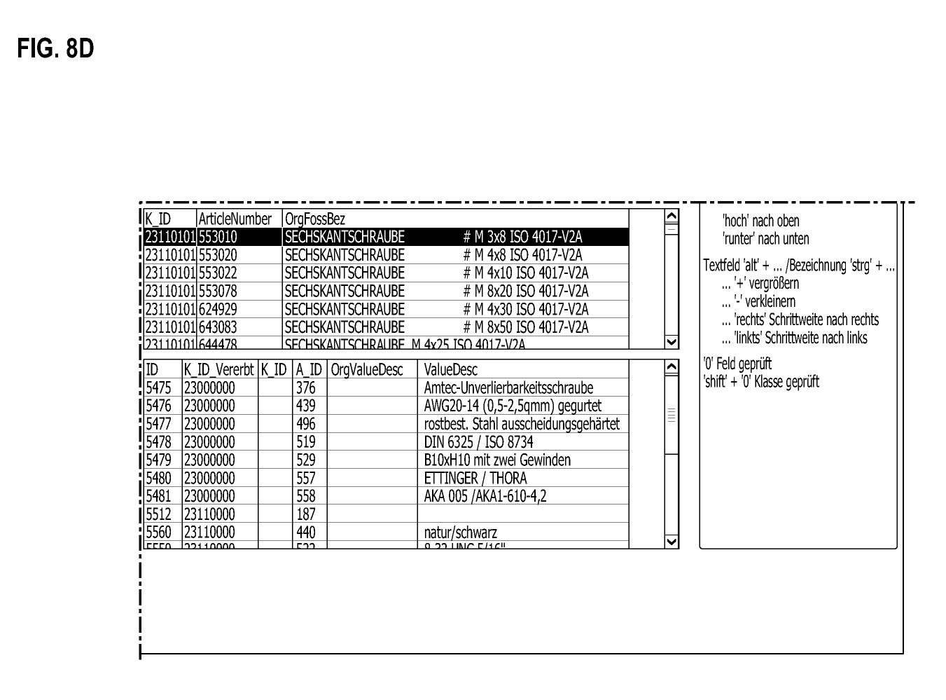

FIGS. 8 and 8A-8D show by way of example a mask for a mask designer. A representation or illustration of the following properties takes place in this mask:
Data types
Compulsory field
Checking function
Selection function
“not in the list”
“not yet checked”.

Here the following definitions are also made and input into the system:
Checking function
Selection function
Compulsory field
negative values
Display field in the list and calculate the maximum values
Sequence in the list.

The minimum possible distances between the fields and the titles is also calculated in order to achieve as compact a representation of the mask as possible. For greater clarity the mask is structured into a number of different fields. The fields comprise several tables for the parts data sets and their configuration, so-called group boxes, in each of which a number of input fields correlating to specific aspects or subjects are brought together or grouped. These include input fields relating to the basic data (e.g. parts number, material group, designation, standard etc.), input data relating to the physical properties (e.g. control field, density, net volume, net weight etc.), data for the history of each parts data set (e.g. data regarding revision, version, status etc.), input data fields for technical classification (e.g. comprising manufacturer's details, selection functions, identification tips, keywords, labels etc.). In the central area of the mask which is represented in FIGS. 8 and 8A-8D are representations or part-representations which can be scrolled in respect of the structure of the data. In the right-hand area of the mask represented in FIGS. 8C-8D there are a legend and notes which are used within the framework of a checking and testing of the parts data sets. Here, for example, warnings can be issued if inconsistent data sets have been acquired.

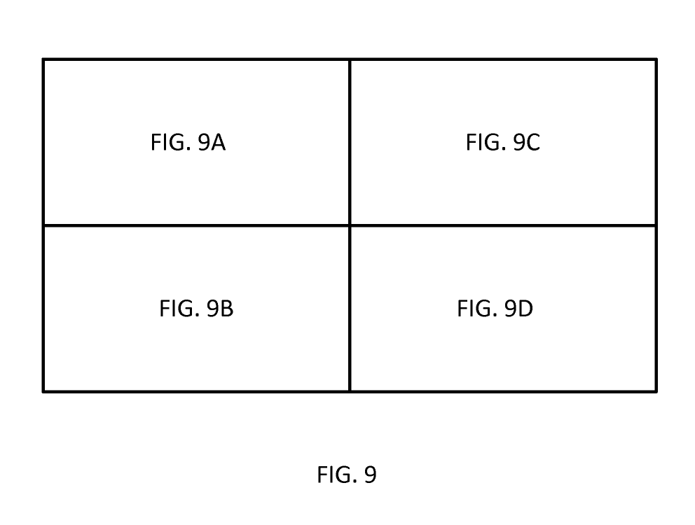

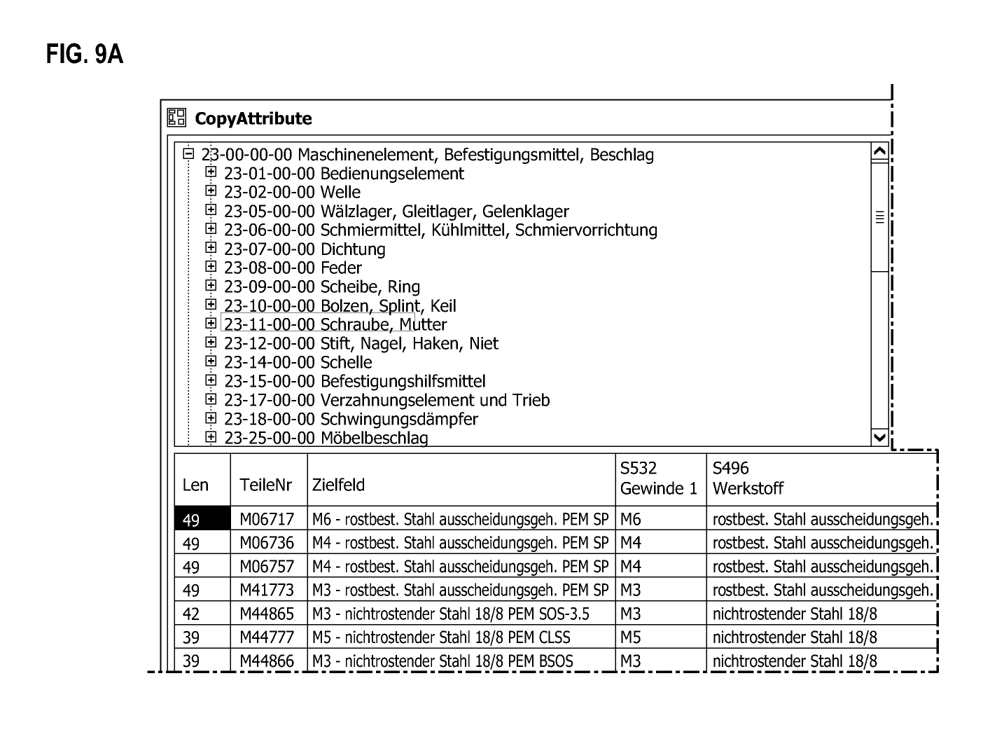

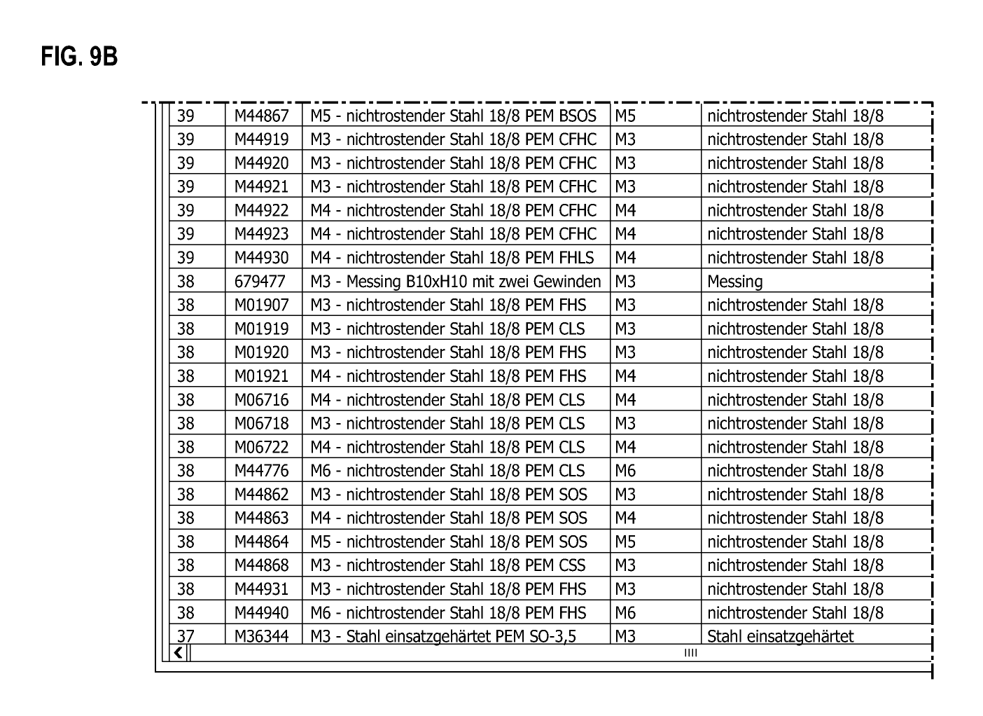

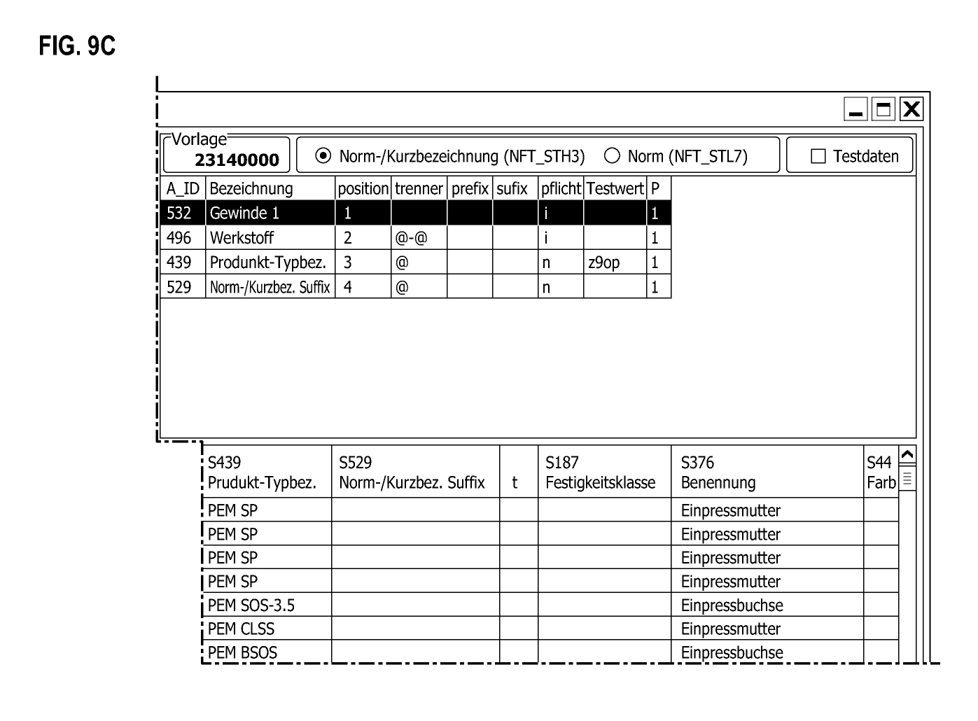

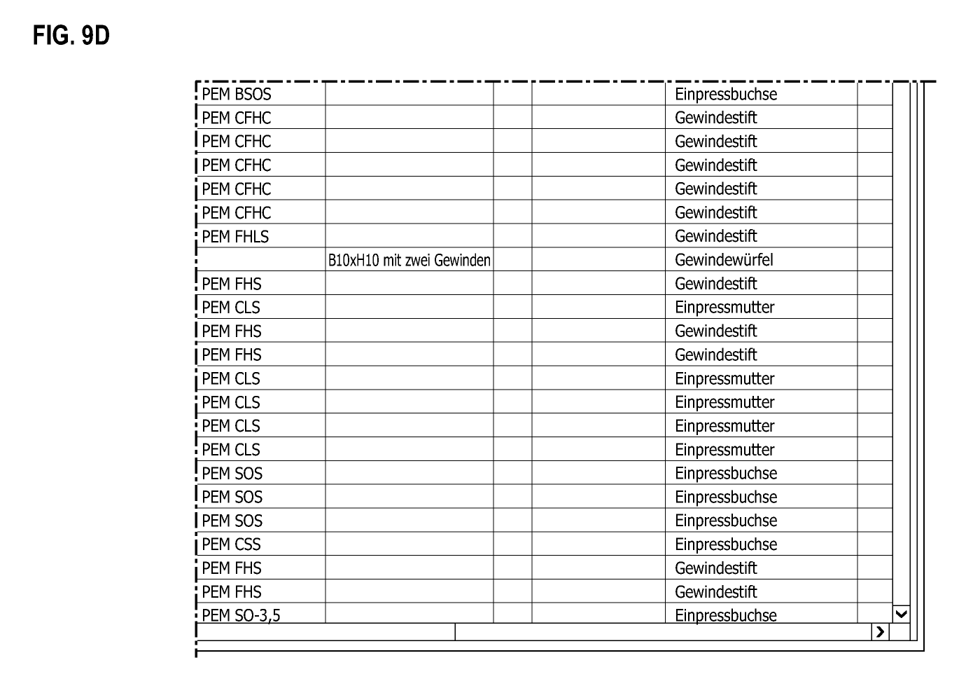

FIGS. 9 and 9A-9D show an example of a mask for label aggregation. During the label aggregation a preconfigurable number of labels are aggregated to form a label group. The label group can be identified by an abbreviation. Preferably a bijective allocation protocol is provided between the abbreviation and the label aggregation. In the example represented in FIGS. 9 and 9A-9D, in the top left-hand field of the mask there is a selection of labels of the classification protocol. Labels not currently displayed can be displayed by moving the scrollbar on the right-hand side. In the top right-hand field there is an illustration of the abbreviations. Source fields and target fields are represented in the bottom area. In each case, a target field is calculated in real time from the respective source field. The target field can then relate to a label aggregation, for example quoting “M3, stainless steel 18/8, CFHC”.

The sequence of a configuration method according to a preferred embodiment according to the invention is explained in more detail below with reference to FIG. 5.

After starting the system in method step A the classified and labelled parts data sets 100 are read in from the data memory 10.

Configuration requirements 600 of the product data management system P are read in step B.

Process conditions 500 of the treatment or use process for the medico-technical parts are acquired in step C.

Step A to C can also be carried out in a different order and are carried out in particular in a preparatory phase.

This is followed by a second, execution phase, temporally decoupled or at least decouplable, which comprises steps D and E.

The process-adapted data structure 70 for the parts data sets and/or of configuration instructions 700 are automatically generated in step D based on the acquired process conditions 500 and/or based on the read-in configuration requirements 600.

The product data management system P is automatically configured in step E. The configuration usually comprises carrying out configuration instructions 700 inside the product data management system P. A process-adapted data structure 70 can optionally also be imported into the product data management system P.

As represented in FIG. 5, it is possible to provide a checking and testing phase within the framework of the configuration. Preferably the checking and testing phase can also be carried out parallel to the configuration. This is represented in FIG. 5 by carrying out a test is carried out after carrying out step D or before the automatic configuration E. The scope of the test be different and end with the result “successful” or “not successful”. Depending on the embodiment, a possible setting is that the configuration in step E is carried out only when the test result is successful. Otherwise (test result not successful), there can be a further branching to the start. The testing can comprise a check for duplicates, a check for inconsistent data sets, a check on the user (e.g. comprising a check whether the user in question is also authorized to carry out configuration), a check on the technical circumstances (e.g. whether all interfaces are available, whether sufficient technical resources are available etc.).

Accordingly, the method according to the invention is broken down into two time phases:
1. into a preparatory phase and
2. into an execution phase, wherein the two time phases are basically independent of one another and can also be temporally decoupled.

Thus the configuration E can be carried out at a choosable point in time once the preparatory phase is completed. It is thus not necessary for the product data management system P to be configured immediately after the conclusion of the preparatory phase. This can also be temporally deferred in order to achieve a temporal variability and for example then carry this out when the load on the resources of the product data management system P is as low as possible (e.g. at night).

The process-adapted data structure 70 differs from the (read-in) data structure inasmuch as, when producing the process-adapted data structure 70, test functions and/or checking functions and/or validation functions are or have been carried out. These include checking for inconsistent data sets, checking to avoid duplicates, checking whether the data structure is optimally adapted to the production sector 25 with the process conditions 500, checking whether the data structure is optimally tailored to the real data and whether all the configuration requirements 600 are met. In more complex embodiments further checking functions can still be carried out here. The result of the above-named functions can likewise be represented on one of the above-described masks. The checking usually takes place in real time.

The automatic configuration allows as optimum as possible an adaptation to the respective application-specific circumstances to be achieved. Depending on the scope of the product data management system this comprises different functionalities (e.g. the production of parts lists, the issuing of an object status and of a workflow, the representation of different versions of a product, a user administration, a management of user rights, the blocking of objects if competing changes are simultaneously to be made to an object, which usually leads to inconsistent data sets, record keeping and management of master records, format conversion and further functions). Different configuration settings are required depending on which specific functions are displayed in the product data management system P. This can be optimally displayed by the dynamic adaptation of the configuration method according to the invention.

A further aspect of the present invention is characterized by the provision of a tracer module (not represented in the Figures). The tracer module serves to store all configuration settings and/or all actually applied configuration instructions. Thus it is also possible to retrieve different configuration settings, retrospectively, and possibly (after inputting a confirmation signal) import these into the product data management system P for restoration of original configurations.

In an embodiment variant the configuration system according to the invention is designed more simply and dispenses with the generation of a process-adapted data structure. In this variant it is assumed that the read-in, classified and labelled parts data sets 100 have already been subjected to an optimization process. In other words the matching to the process conditions 500 and/or to the respective application situation is already carried out in advance. The configuration is then characterized merely by the automatic generation of configuration instructions 700. Both the acquired process conditions 500 and the read-in configuration requirements 600 are taken into account. The configuration instructions 700 can, as already mentioned above, be forwarded via a file to the product data management system P for execution and activation (optionally also at a later point in time). In this case the importing of the process-adapted data structure 70 is dispensed with. The automatic generation of a process-adapted data structure is also dispensed with. This variant of the invention has the advantage that the configuration can be carried out more simply and more quickly and fewer data need be forwarded to the product data management system P for configuration.

The following can be recorded as substantial advantages of the configuration system K according to the invention:

With the configuration system K according to the invention it is possible to generate a configuration interface for different product data management systems P in order to configure these. Thus the configuration can be very flexibly optimized to the respective case of application. Furthermore, these can be carried out more securely, at more favourable cost and more simply by the automated configuration. Furthermore the configuration can be tailored very specifically to the underlying real data or parts data. Non-relevant classes and labels are not taken into account during configuration.

The above detailed description of the Figures relates to the application for the production sector of dialysis technology. The ECL@SS standard can, however, also be used for other objects from other technical fields. It is also possible, in addition to the ECL@SS standard, to also provide further alternative classification protocols. This results in a further advantage in that the configuration according to the invention can also be applied to different classification systems.

In principle, the implementation of the configuration system K according to the invention is not limited to a specific computer platform and can for example also be developed in a client-server architecture, in a cloud architecture or as legacy mainframe application. According to an aspect of the invention, the implementation of the configuration system K according to the invention is based on a client-server system. It may be based on a .NET platform with corresponding libraries and components. In an embodiment example the configuration system is implemented in SQL, C#, .NET. Xml interfaces are used as interfaces. Further storage entities, also including cache memories, which serve to store configuration-relevant data can also be provided. These can be held permanently in a memory. The storage parts comprise random access memories (RAM), static random access memories (SRAM parts), dynamic random access memories (DRAM parts), flash memories or other types of storage parts which can be accessed by a central processing unit (CPU) in order to retrieve the configuration-relevant information. The data transmission over the interfaces is not limited to a specific protocol or network. Preferably a local area network (LAN) is provided here which for example is based on a TCP/IP protocol (transmission control protocol/internet protocol, optionally in different versions). The data to be transmitted can be transmitted as separate or bundled messages and forwarded to different computer-based entities via a router. Conversion and compression algorithms can also be applied to convert and/or compress the data to be transmitted (for example the configuration instructions 700). Different compression algorithms can be applied. Furthermore, the configuration system K can comprise an interpreter which is intended to interpret, from the read-out configuration requirements 600 and process conditions 500, corresponding data sets which can be used within the framework of the configuration and/or serve to configure the PDM system P.

In summary the present invention can be described as follows:

With the configuration system K according to the invention an adapter is provided as configuration interface for different product data management systems P. The adapter takes into account firstly both the prerequisites and requirements of the respective product data management system P and/or (preferably cumulatively) also the respective conditions, in particular process conditions 500, of the respective application which are to be carried out with the underlying parts. During application this can involve the production of the parts or the technical use of same. Furthermore the configuration is based exclusively on real data which are read-in via a separate interface.

It is self-evident to a person skilled in the art that the above detailed description of the Figures is to be understood only by way of example and the scope of protection of the present application is not limited by the examples.

### LIST OF REFERENCES

K Configuration system
P Product data management system, in particular Pro.File
10 Data memory
100 Parts data set
500 Process conditions
600 Configuration requirements
700 Configuration instructions
ERP ERP system
O Data optimizer
S Data validation and structuring system
20 Parts data set interface
25 Production sector
30 Product data management system interface
50 Process memory
60 Configuration requirements memory
70 Process-adapted data structure
80 Configuration memory
90 Configurator
A Reading-in of classified and labelled parts data sets
B Reading-in of configuration requirements 600 of the product data management system P
C Acquisition of process conditions
D Automatic generation of a process-adapted data structure 70
E Automatic configuration

1. Computer-implemented system for configuring an electronic product data management system for processing parts data sets which represent medico-technical parts, and wherein the parts data sets are present, classified and labelled according to a classification protocol, in a data structure of a physical data memory, comprising:
a parts data set interface which is intended to read in the classified and labelled parts data sets from the data memory;
a product management system interface which is intended to read in configuration requirements) of the product data management system;
a process memory in which acquired process conditions of a process for processing the medico-technical parts are stored;
a process-adapted data structure for the parts data sets;
a configuration memory to store configuration; instructions based on the acquired process conditions; and/or the read-in configuration requirements; and
a configurator which is intended to automatically configure the product data management system by:
importing the process-adapted data structure into the product data management system and by; and
activating the configuration instructions from the configuration memory.

2. System according to claim 1 in which the classification protocol has a four-step hierarchy.

3. System according to claim 1, in which the classification protocol is based on an ECL@SS standard and/or in which relevant classes and labels are selected from the ECL@ASS standard and adopted for the process-adapted data structure.

4. System according to claim 1, in which the generation of the process-adapted data structure comprises a checking for admissibility and/or a validation of the parts data sets.

5. System according to claim 1, in which at least one configuration file is produced which is intended to import and/or export data into/out of the product data management system.

6. System according to claim 1, in which during the configuration parts data sets can also be validated, altered, deleted and/or added.

7. System according to claim 1, in which the configurator is intended to prompt each class to specifically automatically generate input masks based on the read-in parts data sets, the read-in configuration requirements and/or the acquired process conditions.

8. System according to claim 1 in which the process-adapted data structure comprises only classes and/or labels selected and relevant to the respective process.

9. System according to claim 1, in which, to automatically configure each class, the configurator accesses a class-specific, process-specific and/or product data management system-specific allocation protocol, by means of which a keyword is stored for each label or each label group.

10. System according to claim 1, in which a grouping protocol is provided according to which a group of parts data sets can be formed which match the preconfigurable labels and are brought together to form a label aggregation.

11. System according to claim 1, in which the configuration instructions are intended to automatically generate input masks for title definition, for field specification and/or label aggregation.

12. Computer-implemented method for configuring an electronic product data management system for processing parts data sets which represent medico-technical parts, and wherein the parts data sets are present, classified and labelled according to a classification protocol, in a data structure of a physical data memory, comprising the following method steps:
reading-in of the classified and labelled parts data sets from the data memory;
reading-in of configuration requirements of the product data management system;
acquisition of process conditions of a process for treating the medico-technical parts;
automatic generation of a process-adapted data structure for the parts data sets and/or of configuration instructions based on the acquired process conditions and/or on the read-in configuration requirements; and
automatic configuration of the product data management system by:
importing the process-adapted data structure into the product data management system; and
activating the configuration instructions.

13. The method according to claim 12 further comprising reclassifying the parts data sets, read-in and structured according to the classification protocol, accessing a second classification protocol.

14. Computer program product for configuring an electronic product data management system for processing parts data sets, wherein the computer program product comprises a computer program which is stored on a data carrier or memory and comprises the commands readable by a computer which are intended to carry out the method claimed above according to claim 12 when the commands are carried out on the computer.
